(19) United States
(12) Patent Application Publication
(10) Pub. No.: US 2010/0147760 A1
(43) Pub. Date: Jun. 17, 2010

(54) FILTER CARTRIDGE CONTAINING RETICULATED FOAM FLUID TREATMENT MEDIA

(76) Inventors: David Leavitt, Emond, OK (US); John Famula, Severna Park, MD (US); Christer Broman, Millersville, MD (US); Jeremy Hess, Fayetteville, AR (US); Elmo Walter Geppelt, Tulsa, OK (US)

Correspondence Address: DUNLAP CODDING, P.C., PO BOX 16370, OKLAHOMA CITY, OK, 73113, US

(21) Appl. No.: 12/581,011

(22) Filed: Oct. 16, 2009

Related U.S. Application Data
(63) Continuation-in-part of application No. 11/599,060, filed on Nov. 14, 2006, now abandoned.

(51) Int. Cl. B01D 35/30; B29C 44/32

(52) U.S. Cl. 210/317; 264/415

(57) ABSTRACT

A filter assembly for removing contaminants from a fluid includes a filter housing, a filter cartridge, and a reticulated foam fluid treatment media. The filter housing has an inlet, an outlet and a chamber extending through the filter housing. The filter cartridge is positioned in the chamber of the filter housing and is constructed from a fibrous material used to filter contaminants from a fluid. The reticulated foam fluid treatment media is disposed within a passageway of the filter cartridge. The reticulated foam fluid treatment media includes a porous polymeric substrate having surfaces, including pore walls, and particles secured to the surfaces of the porous polymeric substrate via a binder, the particles being substantially uniformly distributed throughout the porous polymeric substrate via sonic vibration of the porous polymeric substrate and particles.

### CROSS-REFERENCE TO RELATED APPLICATIONS

This application is a continuation-in-part of U.S. patent application Ser. No. 11/599,060 filed Nov. 14, 2006.

### BACKGROUND

1. Field of the Invention

The present invention relates generally to fluid treatment systems and more particularly, but not by way of limitation, to a filter cartridge containing reticulated foam fluid treatment media and methods of making the reticulated foam fluid treatment media.

2. Background of the Invention

Fluid treatment, especially for water is often needed for drinking, bathing, cooking and general household, industrial, military and medical applications. Such fluid treatment desirably includes removing or reducing undesirable biological and/or chemical entities, for neutralizing and counter-acting the harmful effects of such undesired biological and/or chemical entities.

Numerous methods for treating fluids, such as water, to remove undesired biological and/or chemical entities have heretofore been proposed and employed, such as treatment of the water with chlorine, filtration, reverse osmosis, activated carbon and ion exchange.

Fluid treatment media of such treatment systems are complex and expensive. Thus, more simple systems of filtration have often been employed, especially when treating fluid for household use, including the treatment of the water of swimming pools and spas. In addition to removing undesired biological and/or chemical entities from such water, it is also desirable to remove heavy metals from the water. Metals that may be present in such water include copper, chromium, zinc, cadmium, mercury, lead and nickel.

While various processes have been proposed to remove such heavy metals by chemical precipitation, new and improved methods for removing heavy metals, as well as undesirable biological and/or chemical entities are desired. Thus, a need remains for new and effective treatment methods for water and other liquids, particularly for methods and devices that can effectively remove bacteria, undesirable chemicals and heavy metals from the water supply, especially when utilizing such water in swimming pools and spas.

### SUMMARY OF THE INVENTION

According to the present invention, a filter assembly having a cartridge containing a reticulated foam fluid treatment media is provided for treating fluids, such as water and air. Broadly, the filter assembly for removing contaminants from a fluid includes a filter housing and a filter cartridge having a reticulated foam fluid treatment media disposed therein. The filter housing has an inlet, an outlet and a chamber extending through the filter housing. The filter cartridge is positioned in the chamber of the filter housing, and is constructed from a fibrous material used to filter contaminants from a fluid. The filter cartridge has a passageway extending from a proximal end of the filter cartridge to a distal end of the filter cartridge. The reticulated foam fluid treatment media is disposed within a portion of the passageway of the filter cartridge, and includes a porous polymeric substrate having surfaces including pore walls, and particles secured to the surfaces of the porous polymeric substrate via a binder. The particles are substantially uniformly distributed throughout the porous polymeric substrate via sonic vibration of the porous polymeric substrate and particles.

In one embodiment, the filter assembly is provided for removing contaminants from a fluid and is operably connected to a supporting structure. The filter assembly includes a filter housing having an inlet, an outlet and a chamber extending therethrough; a filter cartridge positioned in the chamber of the filter housing; and a substantially flexible reticulated foam fluid treatment media embedded within the filter cartridge. The filter cartridge is positioned in the chamber of the filter housing and is constructed from a fibrous material used to filter contaminants from a fluid. A substantially flexible reticulated foam fluid treatment media is embedded within the filter cartridge. The reticulated foam fluid treatment media includes a flexible porous polyurethane substrate having surfaces including pore walls, and particles secured to the surfaces of the porous polyurethane substrate via a binder. The particles are substantially uniformly distributed throughout the porous polyurethane substrate via sonic vibration of the porous polyurethane substrate and particles.

In yet another embodiment, a method is provided for producing flexible reticulated foam fluid treatment media for removing contaminates from fluids. The method includes the following steps. A flexible porous polymeric substrate is provided and coated with a compatible binder. The coated flexible porous polymeric substrate is compressed using a roller or pair of rollers to press the binder into pores of the flexible porous polymeric substrate and to remove excess binder from the pores. The flexible porous polymeric substrate re-expands after passing through the roller or pair of rollers to provide a coated flexible porous polymeric substrate having tacky surfaces. An effective amount of particles are applied to a face of the coated flexible porous polymeric substrate and sonic vibration is applied. The sonic vibration causes the particles to become uniformly distributed throughout the porous polymeric substrate. In this way, the particles uniformly coat the tacky surfaces of the coated flexible porous polymeric substrate, thereby providing a particle coated flexible porous polymeric substrate. The particles are typically metal particles, metal oxide particles, carbon particles and combinations thereof.

If required, the reticulated foam fluid treatment media can be stabilized within the passageway of the filter cartridge with a piece of porous material wrapped about at least a portion of the reticulated foam fluid treatment media so as to stabilize same within the passageway of the filter cartridge. When the filter cartridge is provided with a substantially flexible fluid treatment media, the filter cartridge may further be provided with a cartridge retainer member for stabilizing the substantially flexible fluid treatment media in the central passageway of the filter cartridge.

In still another aspect, a filter cartridge is provided which includes a reticulated foam fluid treatment media section embedded within the filter cartridge.

### BRIEF DESCRIPTION OF THE SEVERAL VIEWS OF THE DRAWINGS

FIG. 1 is a perspective view of a reticulated foam fluid treatment media constructed in accordance with the present invention.

FIG. 2 is a partial cross-sectional view of a filter housing containing a filter cartridge, the filter cartridge having the reticulated foam fluid treatment media of FIG. 1 disposed within a passageway of the filter cartridge.

FIG. 3 is a fragmental, partial cross-sectional view of the filter housing having a filter cartridge containing the reticulated foam fluid treatment media of FIG. 1 therein, the filter housing having a cartridge retainer disposed adjacent an outlet of the housing for stabilizing the reticulated foam fluid treatment media within the passageway of the filter cartridge.

FIG. 4 is a perspective view of the cartridge retainer of FIG. 3.

FIG. 5 is a fragmental, partial cross-sectional view of the filter housing having the filter cartridge containing the reticulated foam fluid treatment media of FIG. 3 wherein a piece of fluid permeable material is disposed about at least a portion of the reticulated foam fluid treatment media to stabilize same within the passageway of the filter cartridge.

FIG. 6 is an isometric, partially cut-away view of another embodiment of a filter cartridge constructed in accordance with the present invention wherein a reticulated foam fluid treatment media is embedded within the filter cartridge and forms a section thereof.

FIG. 7 is a view of the reticulated foam fluid treatment media resulting from Test D after cutting in half.

FIG. 8 is a view of the faces radial and longitudinal cross-sections of the reticulated foam fluid treatment media resulting from Test A.

FIG. 9 is a view of longitudinal cross-sections of the reticulated foam fluid treatment media resulting from Test A.

FIG. 10 is a view of radial and longitudinal cross-sections of the reticulated foam fluid treatment media resulting from Test B.

FIG. 11 is a view of longitudinal cross-sections of the reticulated foam fluid treatment media resulting from Test B.

FIG. 12 is a view of radial cross-sections of the reticulated foam fluid treatment media resulting from Test C.

FIG. 13 is an additional view of radial cross-sections of the reticulated foam fluid treatment media resulting from Test C.

FIG. 14 is a view of radial cross-sections of the reticulated foam fluid treatment media resulting from Test E.

FIG. 15 is a view of longitudinal cross-sections of the reticulated foam fluid treatment media resulting from Test E.

### DETAILED DESCRIPTION OF THE INVENTION

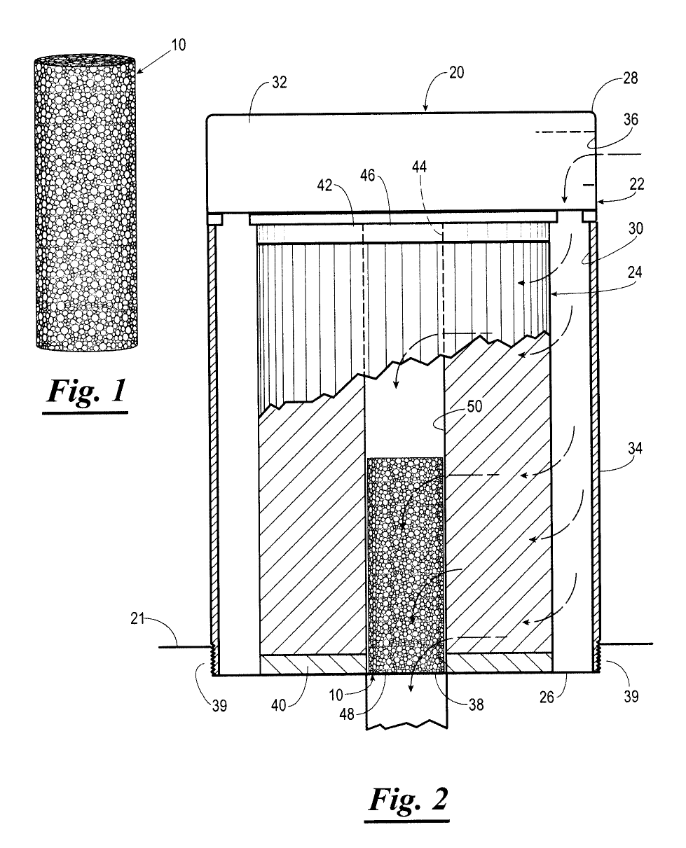

Referring now to the drawings, and more particularly to FIG. 1, shown therein is a reticulated foam fluid treatment media 10 constructed in accordance with the present invention. The reticulated foam fluid treatment media 10 can be (a) a flexible reticulated foam fluid treatment media which is capable of promoting a wide variety of fluid treatment functions including oxidation/reduction reactions, catalytic reactions and chemical absorption of contaminants in fluid to be treated; or, (b) a substantially rigid reticulated foam fluid treatment media which includes metal particles bound together in an interconnected form of a porous metal, sponge-like structure; or, (c) combinations of (a) and (b). The fluids treatable can be a gas such as for example air, or a liquid such as for example water.

The flexible reticulated foam fluid treatment media 10 employed in combination with a filter cartridge includes a flexible porous substrate coated with particles, including but not limited to, rare earth particles, metal particles, metal oxide particles including activated alumina particles, and carbon particles including activated carbon particles, and mixtures thereof. The particular combination of particles will be dependent upon the particular contaminants present in the fluid to be treated utilizing the filter cartridge containing the flexible reticulated foam fluid treatment media 10. For example, when the flexible reticulated foam fluid treatment media 10 contains a mixture of activated carbon and copper/zinc metal particles, the media can be used to treat fluids by the synergistic action of absorption of contaminants onto the activated carbon and the catalyzed oxidation/reduction of contaminants by the copper/zinc metal particles. For some applications, it may also be desirable to add an antimicrobial agent such as povidone-iodine (PVPI) to the particles.

In preparing the flexible reticulated foam fluid treatment media, a soft or flexible porous polymeric substrate is selected having a reticulated pore structure, i.e., the pores are not closed, but rather generally communicate with each other and with the external surface of the porous polymeric substrate. The porous polymeric substrate may be cut to a desired shape conforming to the application or to the device in which the treatment media will be contained. A binder is selected which is compatible with the flexible porous polymeric substrate and which can be applied neat, or may be diluted with water or another appropriate solvent prior to coating onto the porous polymeric substrate. In an embodiment, the porous polymeric substrate is allowed to soak in the binder material. Excess binder is then removed by passing the resulting binder-rich substrate through a roller press whereby excess binder material is removed from the substrate by compressing the substrate between two rollers, or between a single roller and a surface, to squeeze out any excess binder, after which the substrate is allowed to decompress. Typically, the binder-coated porous polymeric substrate is allowed to dry to a tacky state prior to applying the coating materials. In one embodiment, the binder-coated porous polymeric substrate is inserted into a support frame and the support frame is placed in a vacuum coater for application of the coating materials. Coating materials are added to the top face of the binder-coated substrate and the binder-coated substrate and coating materials are exposed to sonic vibration while a vacuum is applied to the bottom face of the binder-coated substrate. The system is tuned to the optimum frequency for sonic vibration and to the optimum vacuum conditions. The sonic vibration causes the coating materials to distribute uniformly throughout the binder-coated substrate such that the substrate becomes uniformly coated with the coating materials throughout the volume of the substrate. In an embodiment, the resulting coated foam substrate is removed from the support frame, flipped over, and reinserted into the support frame such that the formerly top face of the coated substrate is now the bottom face of the substrate. Additional coating material is placed on the top face of the substrate while continuing to apply sonic vibration and vacuum to the bottom face of the coated substrate, thus providing a targeted amount of coating material to the substrate and providing a uniform coating throughout the volume of the substrate. The coated substrate is removed from the support frame and cured. Different binders require different steps to “cure.” For example, curing can require or involve a drying process, exposure to light, absence of O², etc. In one embodiment, the coated substrate is placed upon a drying rack, and dried for the necessary time, typically a minimum of 24 hours, to allow the binder to cure. The finished flexible foam fluid treatment media can then be cut to the desired shape, if necessary, into the desired shape for the required application.

The compression step can be accomplished using any mechanical apparatus capable of pressing the binder into the pores and irregular surfaces of the flexible porous polymeric substrate, thereby eliminating air pockets and insuring a strong, seamless and stable bond between the substrate and the binder, and subsequently allowing the flexible porous polymeric substrate to decompress. Compression squeezes out any excess binder from the pores such that the pore passages between the pore walls of the reticulated foam material are free of binder and porous to all fluids, including air and water. For example, compression of a binder-coated reticulated foam substrate can be accomplished by passing the binder-coated reticulated foam substrate through a gap formed between two rollers where the size of the gap, i.e., the distance between the rollers, is correlated to the amount of compressive force applied to the substrate. The gap is set by applying tension to the rollers so that a hill surface of one roller meshes with a valley surface of the other roller which assists in feeding the binder-coated reticulated foam substrate through the rollers.

Adjusting the tension applied to the rollers controls the compressive force applied to the substrate. The amount of compressive force applied to the coated foam substrate is an important factor in the method of preparation of the flexible reticulated foam fluid treatment media 10 because too small applied force results in an unevenly applied coating of the binder onto the substrate, resulting in an unstable bond between the substrate, the binder and the particle materials, and too great of an applied force damages the binder-coated material and closes off the open pores and void spaces inherent in the flexible reticulated foam fluid treatment media 10, thereby reducing the porosity and surface area of the flexible reticulated foam fluid treatment media 10 and its effective use in fluid treatment.

The binder-coated substrate is placed into a support frame consisting of a metal cage-like structure that allows air to flow through the binder-coated substrate upon application of a vacuum to the bottom face of the substrate while preventing the substrate from deforming or collapsing during the vacuum step. The support structure that contains the binder-coated substrate is inserted into a tube or hose that is connected to the suction side of a blower, and vacuum is applied to the binder-coated substrate by the flow of air generated by the blower. Coating material is distributed over the top face of the binder-coated substrate while a vacuum is applied to the bottom face of the substrate, and the vacuum draws the coating material into the interior of the substrate. The combination of the blower, blower hose or tube and the substrate support frame comprises the coater referred to herein.

Sonic vibration is applied to the binder-coated substrate during the coating step in order to facilitate the transfer of coating material from the top surface of the substrate throughout the substrate. Sonic vibration is generally considered and is defined herein to be vibration within the range of human hearing: about 16 Hz to about 20,000 Hz, or about 960 min⁻¹ to about 1,200,000 min⁻¹. Sonic vibration can be applied using any of a number of pneumatic ball, rotary or turbine vibration devices that are capable of imparting varying vibration forces at varying vibration frequencies. In selected tests of the invention, sonic vibration was applied using an NTS Model 180NF pneumatic linear vibrator, but any number of similar devices can be used for this purpose. One or more of such sonic vibration devices can be used to apply sonic vibration forces to sides and surfaces of the binder-coated substrate during coating, and the vibration frequency is selected to optimize the application of the coating material to substrates that vary in thickness and in response to the varying physical properties of different coating materials. Typically, sonic vibration is applied using a frequency in the range of from about 6,000 min⁻¹ to about 20,000 min⁻¹; however, the optimum frequency will vary depending on the size and nature of the particles and binder-coated substrate.

During the preparation of the flexible reticulated foam filter media, it is particularly important to “tune” the coater or optimize vacuum and sonic vibration frequencies in order to obtain a uniform coating of the coating materials onto the surface areas of the binder-coated foam substrate. Insufficient vacuum or inadequate sonic vibration will result in some areas of the binder-coated substrate remaining uncoated with coating particles while other areas are coated with an excess amount of coating material to the extent that the pores of the substrate are obstructed or blinded off from the flow of the fluids to be treated. Areas of the finished media that are not adequately coated with coating material will not effectively treat and remove contaminants from the fluid being treated, resulting in poor performance and failure of the media. Although a wide range of vacuum conditions, ranging from no vacuum to a vacuum of over 100 inches of water, are useful for transporting the coating material into the interior of the binder-coated substrate, good coating distribution and loading are preferably achieved using a vacuum in the range of from about 20 inches to about 100 inches of water, and more preferably in the range of from about 30 inches to about 70 inches of water. In one embodiment, the coating distribution and loading are optimized at around 35 inches of water using the blower along with the application of sonic vibration to the substrate.

The flexible foam substrate employed in the construction of the flexible reticulated foam fluid treatment media 10 can be fabricated of any flexible, porous material, such as polymeric or composite material that can provide the reticulated foam fluid treatment media 10 with the desired flexibility, stability, porosity and pore size. Examples of various flexible polymeric materials which can be employed as the flexible foam substrate include, but are not limited to, polyethylene, polyether, polypropylene, polyurethane, polyester, polystyrene, polycarbonate, copolymers of acrylic and non-acrylic polymers, blends thereof, and the like.

The pore density or number of pores per lineal inch (ppi) of the flexible foam substrate employed to produce the flexible reticulated foam fluid treatment media 10 can vary widely, and selection depends in part on the particles to be applied and the fluid to be treated. As understood by those skilled in the art, both the number of pores and the size of the pores in the flexible foam substrate determine the surface area. Desirable results have been obtained for flexible foam substrates coated with activated carbon wherein the ppi is in the range of from about 65 to about 100. Flexible foam substrates with a ppi of 10 to 20 have also shown desirable results when coated with copper/zinc alloy particles. For some applications, a flexible foam substrate having about 300 ppi is desirable. While any suitable polymeric or composite material having the before-defined characteristics can be employed as the flexible foam substrate in the fabrication of the flexible reticulated foam fluid treatment media 10 of the present invention, especially desirable results have been obtained wherein the flexible foam substrate is produced from a polyurethane having a pore density as described above.

The binder employed in the construction of the flexible reticulated foam fluid treatment media 10 can be any binder compatible with the flexible foam substrate, the particles embedded in the binder/flexible foam substrate, and the flexible reticulated foam fluid treatment media 10 and which is capable of being cured at room or ambient temperatures. Examples of such binders include, but are not limited to, acrylic glue, polychloroprene cement, neoprene rubber cement, polychlorinated rubber adhesive, phenolic resin, resorcinol glue, phthalate ester adhesive, silicon glue, and polyurethane glue.

The coating material applied to the binder-coated substrate can include metal particles, metal oxide particles, rare earth particles, activated alumina particles, non-activated carbon particles, including coal fines and carbon black, activated carbon particles, and mixtures thereof. For example, suitable particles of the flexible reticulated foam fluid treatment media 10 can be selected from a variety of materials including, but not limited to, carbon, brass, bronze, copper, zinc, iron, iron oxide, silver, cerium, lanthanum, tin, nickel, nickel oxide, aluminum, alumina, platinum, palladium rhodium ruthenium, titanium, titania, manganese, manganese oxide, rare earth oxides, and antimony. These particles can be used individually or combined together to form the coating. Desirable results have been obtained where metal particles are bimetallic mixtures containing copper and zinc and trimetallic mixtures containing copper, zinc and silver.

The activated carbon particles employed in the practice of the present invention can be selected from any source of highly porous carbon, such as that derived from coal, pitch, coconut shells, corn husks, polyacrylonitrile (PAN) polymers, charred cellulosic fibers and wood. When utilizing activated carbon as at least one of the particles, the amount of activated carbon present on the flexible foam substrate can vary widely, but will generally be from about 5 to about 45 weight percent.

The size and amount of the particles employed in the construction of the flexible reticulated foam fluid treatment media 10 can vary and will be dependent to a large extent on the fluid to be treated, as well as the flow rate of the fluid through the flexible reticulated foam fluid treatment media 10. The amount of particles present on the flexible reticulated foam substrate will desirably range from about 10 to 98 weight percent based on the weight of the flexible reticulated foam fluid treatment media 10. In one embodiment, the particles are substantially uniformly distributed throughout the porous polymeric substrate in an amount in the range of from about 1.5 g to about 15 g per in³ of porous polymeric substrate. In another embodiment, carbon particles are substantially uniformly distributed throughout the porous polymeric substrate in an amount in the range of from about 1.5 g to about 5 g per in³ of porous polymeric substrate. The average size of the particles present on the flexible reticulated foam substrate will desirably range from about 10 mesh to about 400 mesh, based on U.S. Standard Sieve Series, and more desirably from about 80 to about 200 mesh.

The flexible, reticulated foam fluid treatment media 10, which can be used in combination with a filter cartridge in accordance with the present invention, is described in U.S. patent application Ser. No. 11/351,930, entitled “Flexible Reticulated Foam Fluid Treatment Media and Method of Preparation”, filed Feb. 10, 2006, the disclosure of which is hereby expressly incorporated herein in its entirety by reference.

As previously stated, a rigid reticulated foam fluid treatment media can be used, either per se or in combination with the flexible fluid treatment media, with a filter cartridge to remove various types of contaminants from a variety of fluids. The rigid reticulated foam structured fluid treatment media includes metal particles bound together in an interconnected form of a porous metal, sponge-like structure wherein one (1) cubic inch of the porous metal, sponge-like structure has at least about 325 square inches of surface area.

The metal particles employed in the rigid reticulated foam structured fluid treatment media can vary widely and will be dependant to a large extent on the type of contaminants to be removed by treatment of a fluid. Examples of the metal particles which can be used in the construction of the rigid reticulated foam fluid treatment media are described in U.S. Pat. No. 5,135,654, titled “Method for Treating Fluids” issued to Heskett, Aug. 4, 1992; U.S. Pat. No. 4,642,192 titled “Method of Treating Fluids” issued to Heskett, Feb. 10, 1987; and U.S. Pat. No. 5,122,274, titled “Method of Treating Fluids” issued to Heskett, Jun. 16, 1992, the disclosures of each of which are hereby expressly incorporated herein in their entirety by reference. However, desirable results have been obtained wherein the metal particles are bimetallic mixtures containing copper and zinc, or trimetallic mixtures containing copper, zinc and silver.

The metal particles employed in the preparation of the rigid reticulated foam structured fluid treatment media element can be particles of a copper/zinc alloy commercially available from Fluid Treatment, Inc. of Constantine, Mich. and sold under their mark KDF™. More particularly, particles of a copper/zinc alloy sold by this company and identified by the mark KDF-55™ have been found useful in forming the rigid reticulated foam structured fluid treatment media. The commercially available metal particles described before are in a powder-like form having an average mesh size of about 200 mesh, based on U.S. Standard screen sizes.

To form the rigid reticulated foam structured fluid treatment media which has a sponge-like structure, wherein one (1) cubic inch of the rigid reticulated foam structured fluid treatment media has a surface area of about 325 square inches or more, polyethylene foam is cut to form a substrate having a desired size and shape. The polyethylene substrate is then submerged into a solvent for a period of time effective to provide the polyethylene substrate with a tacky surface. Copper powder is then mixed with a binder to form a slurry and the slurry is applied to the polyethylene substrate. The tacky surface of the polyethylene insures that a substantially uniform coating of the slurry containing copper powder sticks to the surface of the polyethylene substrate.

The slurry-coated polyethylene substrate is allowed to dry under ambient conditions and then placed in a furnace maintained at from about 1950° F. to about 2150° F. for a period of time effective to evaporate the polyethylene substrate and produce a foam structure consisting of copper. During the heating of the slurry-coated polyethylene substrate the furnace is flooded with hydrogen gas.

A 200 mesh powder consisting of metal particles (KDF-55™) is admixed with a binder to form a slurry and the slurry is applied to the foam structure of copper. The slurry-coated foam structure is allowed to dry under ambient conditions and the resulting hardened structure is then placed in a furnace flooded with hydrogen gas and maintained at from about 1950° F. to about 2150° F. for a period of time effective to sinter the copper/zinc alloy and to insure that any trace amounts of foreign material, such as binder and polyethylene, have been gassed off. After the sintering of the copper/zinc alloy has been completed and the impurities have been gassed off, the rigid reticulated foam structured fluid treatment media so produced is then removed from the furnace and allowed to slowly cool to ambient temperature. The rigid reticulated foam structured fluid treatment media so produced has a sponge-like structure wherein one (1) cubic inch of the reticulated foam structured fluid treatment media has a surface area of about 350 square inches.

The particles employed in the formulation of either the flexible reticulated foam fluid treatment media or the rigid reticulated foam fluid treatment media employed in the practice of the present invention can be selected from a variety of materials. Suitable metals and metal alloys include, but are not limited to, brass, bronze, copper, zinc, iron, silver, tin, nickel, aluminum, activated aluminum, cerium, lanthanum, platinum, palladium, rhodium, ruthenium, titanium, manganese, antimony, and combinations thereof. Suitable metal oxides include, but are not limited to, manganese oxide, alumina, iron oxide, titania, nickel oxide and combinations thereof. These particles can be used individually or combined together to form the metal coating. In one embodiment, the preferred metal coating is formed from bimetallic and trimetallic mixtures containing copper and zinc and which are commercially available from Fluid Treatment, Inc. of Constantine, Mich. and sold under their mark KDF™. More particularly, particles of a copper/zinc alloy sold by Fluid Treatment, Inc. and identified by the mark KDF-55™ have been found useful in forming the flexible reticulated foam fluid treatment media and the rigid reticulated foam fluid treatment media used in the practice of the present invention. Further, in certain instances it has been found desirable to incorporate a mixture of particles which contain copper/zinc alloy and silver.

The metal particles employed in the fabrication of the rigid reticulated foam fluid treatment media are desirably in a powder-like form having an average particle size of about 100 mesh, based on U.S. Standard screen sizes. To form the rigid reticulated foam fluid treatment media, one cubic inch of the rigid reticulated foam fluid treatment media has a surface area of about 325 square inches or more.

The rigid reticulated foam fluid treatment media which can be used in combination with a filter cartridge, either per se or in combination with the flexible reticulated foam fluid treatment media and the method of making such rigid reticulated foam fluid treatment media, is disclosed in U.S. Pat. No. 5,599,456, entitled “Fluid Treatment Utilizing a Reticulated Foam Structured Media Consisting of Metal Particles” issued to Chris E. Fanning, Feb. 4, 1997, the disclosure of which is hereby expressly incorporated herein in its entirety by reference.

From the above description of the flexible reticulated foam fluid treatment media and the rigid reticulated foam fluid treatment media, it is readily apparent that the chemical nature of the particles used in the construction of such media can vary widely and the particular mixture of particles will depend on the intended use of the media. Further, it should be appreciated and understood that the fluid treatment media can be a combination of the flexible reticulated foam fluid treatment media and the rigid reticulated foam fluid treatment media.

Referring now to FIG. 2, a filter assembly 20 constructed in accordance with the present invention is shown disposed in a conventional spa 21 to purify or decontaminate the water being used in the spa 21 by removing various contaminants. It should be understood that although the spa 21 is shown utilizing the filter assembly 20, the filter assembly 20 is not limited to use with a spa, but may be used with a wide variety of apparatuses using fluid treatment devices in accordance with the present invention.

Broadly, the filter assembly 20 includes a filter housing 22, a filter cartridge 24, and the reticulated foam fluid media 10. The filter housing 22 is cylindrically shaped and has a proximal end 26, a distal end 28, and a filter chamber 30 extending longitudinally through the filter housing 22 from the proximal end 26 to the distal end 28. Although the filter housing 22 is shown herein to have a substantially cylindrical shape, it will be appreciated that the filter housing 22 may be constructed in a variety of different shapes so long as the filter assembly 20 can accommodate at least one filter cartridge 24 and the reticulated foam fluid media 10 and function in accordance with the present invention. Suitable materials for construction of the filter housing 22 include metals such as aluminum, steel, titanium, magnesium or alloys containing these metals, polymeric materials, and composite materials which are capable of providing the desired strength and durability for the filter housing 22.

A support member 32 is disposed at the distal end 28 of the filter housing 22 to stabilize the filter cartridge 24 in the desired position within the filter housing 22. The filter housing 22 has a sidewall 34 which cooperates with support member 32 and a portion of the spa 21 to define the filter chamber 30, an inlet 36 and an outlet 38 which are in fluid communication with the filter chamber 30. The inlet 36 is shown formed in the support member 32 of the filter housing 22; and the outlet 38 is formed in the proximal end 26 of the filter housing 22. It should be understood that the inlet 36 and an outlet 38 may be formed in a variety of positions in the filter housing 22 so long as the inlet 36 and the outlet 38 are in fluid communication with the filter chamber and function in accordance with the present invention.

The proximal end 26 of the filter housing 22 is adapted to threadingly engage a sidewall 39 of the spa 21. The proximal end 26 of the filter housing 22 may be provided with an annular groove for receiving a seal member, such as an o-ring, to effect a fluid-tight seal between the filter housing 22 and the spa 21.

The filter cartridge 24 is disposed in the chamber 30 of the filter housing 22. The filter cartridge 24 is shown as cylindrically shaped, however, the filter cartridge 24 may be constructed in a variety of different shapes so long as the filter cartridge 24 functions in accordance with the present invention. Suitable materials for construction of the filter cartridge may be fibrous, pleated fabric, paper, wound polymeric fiber, such as propylene, micro fiberglass, cellulose, or combinations thereof. The filter cartridge 24 has a proximal end 40, a distal end 42 and an interior chamber or flow passageway 44 centrally positioned within the filter cartridge 24 extending from the proximal end 40 to the distal end 42 for receiving the fluid and the reticulated foam fluid treatment media 10. The flow passageway 44 has an inlet 46, an outlet 48, and a sidewall 50.

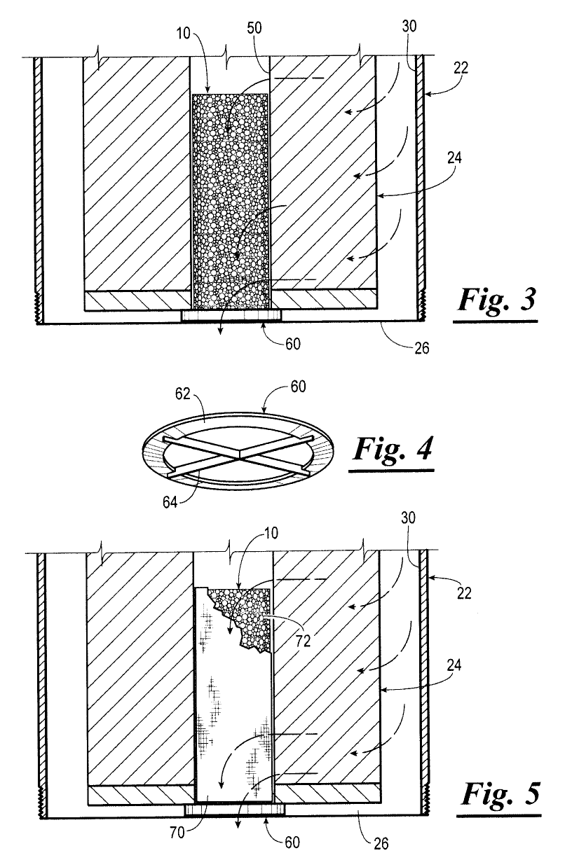

In some situations, the opening of the outlet of the spa or other such apparatus may be larger than the diameter of the reticulated foam fluid treatment media 10 such that the reticulated foam fluid treatment media 10 can fall into the opening, resulting in a clogged opening or damage to the spa. In such cases, as shown in FIGS. 3-5, a cartridge retainer 60 is provided so as to prevent the reticulated foam fluid treatment media 10 from falling into the outlet. The cartridge retainer 60 includes an o-shaped ring 62 having support members 64 extending across the o-shaped ring 62 for engaging a lower portion of the reticulated foam fluid treatment media 10 to stabilize the reticulated foam fluid treatment media 10 in the flow passageway 44 of the filter cartridge 24.

However, it should be understood that the reticulated foam fluid media 10 may be sized to frictionally engage the sidewall 50 of the flow passageway 44 of the filter cartridge 24. Further, referring to FIG. 5, packing cloth 70 may be wrapped about an outer wall 72 of the reticulated foam fluid treatment media 10 to frictionally stabilize the reticulated foam fluid treatment media 10 within the flow passageway 44 of the filter cartridge 24.

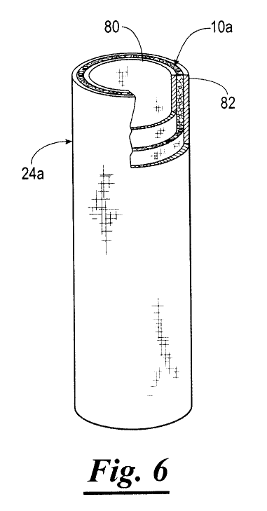

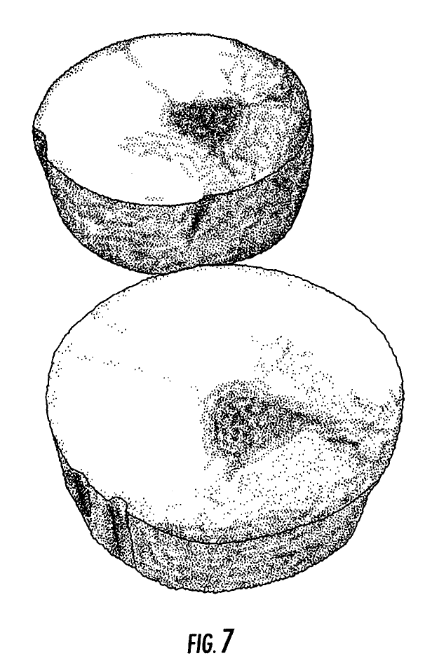

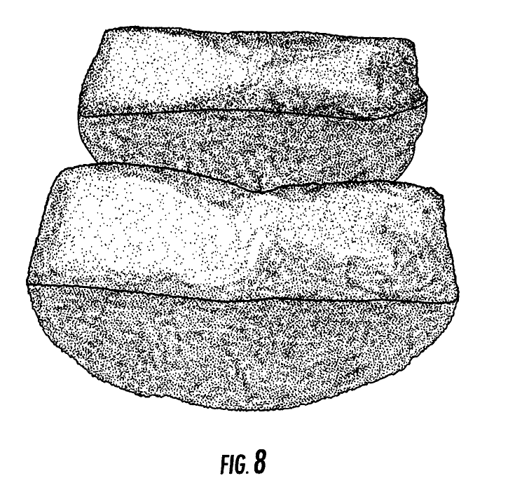

Referring to FIG. 6, a filter cartridge 24a is shown having the reticulated foam fluid treatment media section 10a embedded therein. The filter cartridge 24a, which is useful in treating fluids, can be partially fabricated of a fibrous material, paper and combinations thereof. The filter cartridge 24a is fabricated similar to commercially available fluid treatment cartridges, except that a section of the filter cartridge 24a, either the flexible or rigid reticulated foam fluid treatment media as hereinbefore described, is embedded in the filter cartridge 24a. That is, the filter cartridge 24a is provided with an inner layer 80 and an outer layer 82 of the conventional filter cartridge material and the flexible or rigid reticulated foam fluid treatment media is sandwiched between the inner layer 80 and the outer layer 82 of the conventional filter cartridge material.

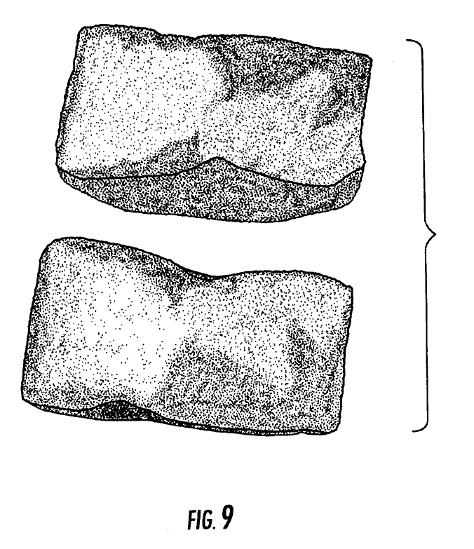

In order to further illustrate the methods and compositions of the invention, the following examples are given. The examples are actually a series of comparative tests, depicted in FIGS. 7 through 15 and summarized in Table 1, that measure the effects of varying sonic vibration conditions at a constant vacuum of 35 inches of water (optimized for the test size and conditions) upon activated carbon coating loading and dispersion for a binder-coated substrate.

### Example 1

In a base test, Test “D” depicted in FIG. 7, a 4.25-inch diameter by 2.5-inch thick binder-coated substrate was coated with activated carbon powder using the procedure described herein, with the exception that a sonic vibration device was not used to facilitate the transfer of powder into the interior of the substrate. Here, an optimized vacuum of 35 inches of water was applied to the substrate by the blower, while the activated carbon was added to the top face of the substrate and the sides of the substrate were shaken and tapped by hand. Then, the coated substrate was removed from the coater and flipped over so that additional powder was applied to the exposed face of the substrate, and the shaking step was repeated. The powder-coated substrate was then removed from the coater, allowed to dry and weighed to determine the loading of activated carbon. The substrate was sliced in half, parallel to the 4.5-inch diameter face, giving radial cross-sections to visually determine the distribution of the coating throughout the substrate. As shown in FIG. 7, a significant volume of the interior of the powder-coated substrate was uncoated with powder, where the uncoated part of the substrate is shown in white in the picture. The distribution of coating material was not optimized by the application of a vacuum without sonic vibration.

### Comparative Example 2

In a second test, Test “A”, the results of which are depicted in FIGS. 8 and 9, a 4.25-inch diameter by 2.5-inch thick binder-coated substrate was coated with activated carbon powder by the general procedure described herein using a sonic vibration device. Here, the frequency of the device was set at 5,520 min⁻¹. The powder-coated substrate was then removed from the coater, allowed to dry, weighed to determine the loading of activated carbon and sliced in half, in a longitudinal direction (perpendicular to the 4.25-inch diameter face) to determine the distribution of the coating throughout the substrate. As shown in FIGS. 8 and 9, sonic vibration increased the loading and improved the distribution of coating material compared to Test “D”, but parts of the substrate remained uncoated with powder.

### Comparative Example 3

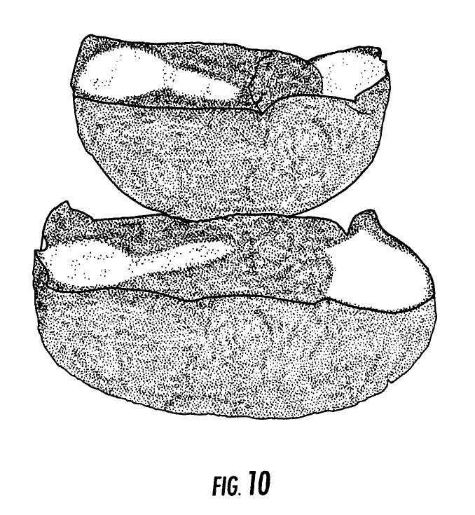

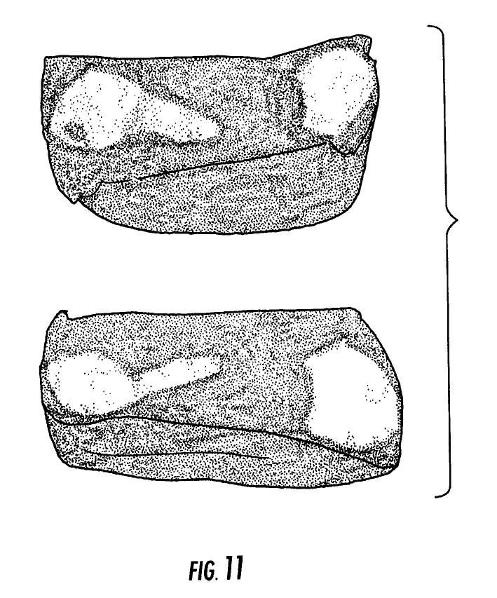

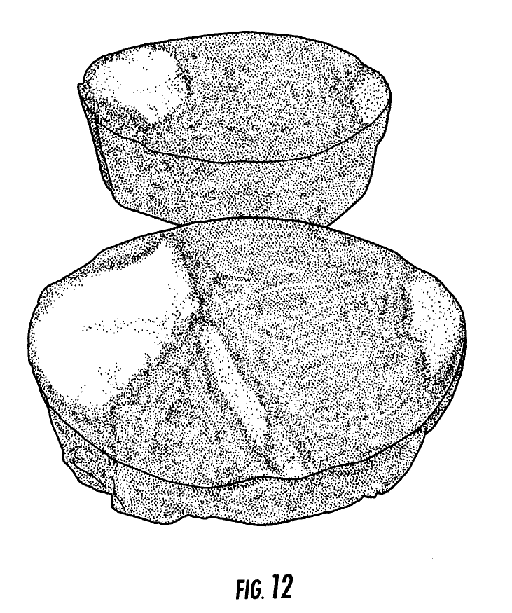

In a third test, Test “B” depicted in FIGS. 10 and 11, a 4.25-inch diameter by 2.5-inch thick binder-coated substrate was coated with activated carbon powder as in Test “B”, but the frequency of the sonic vibration device was set at 6,250 min⁻¹. The powder-coated substrate was then removed from the coater as in the other tests, allowed to dry, weighed to determine the loading of activated carbon and sliced in half to determine the distribution of the coating throughout the substrate. As shown in FIGS. 10 and 11, increasing the frequency of sonic vibration increased the loading and improved the distribution of coating material compared to Test “A”, but coating was still not optimized.

### Comparative Example 4

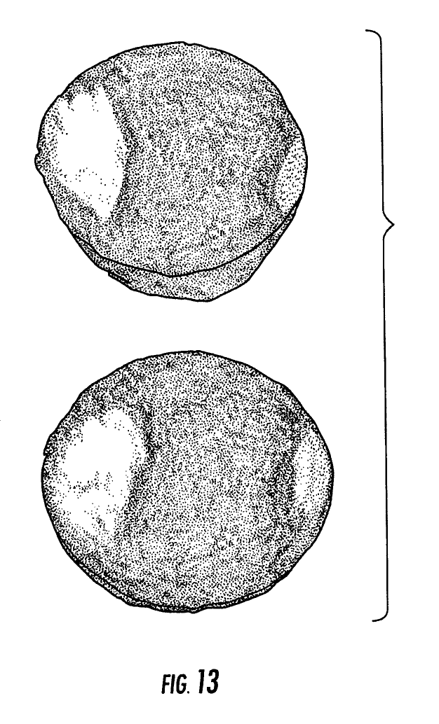

In a fourth test, Test “C” depicted in FIGS. 12 and 13, a 4.25-inch diameter by 2.5-inch thick binder-coated substrate was coated with activated carbon powder as in the previous tests but the frequency of the sonic vibration device was set at 6,880 min⁻¹. When the powder-coated substrate was weighed and sliced in half, the distribution of the coating appeared to be significantly improved compared to the other tests. As shown in FIGS. 12 and 13, some of the interior of the binder-coated substrate did not appear to be coated with activated carbon, and some of the coated area appeared to be lighter in color compared to other areas, indicating that the coating may not be uniformly applied throughout the substrate.

### Comparative Example 5

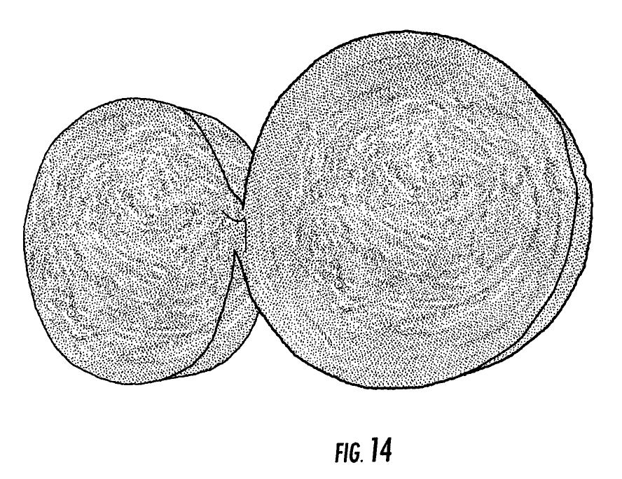

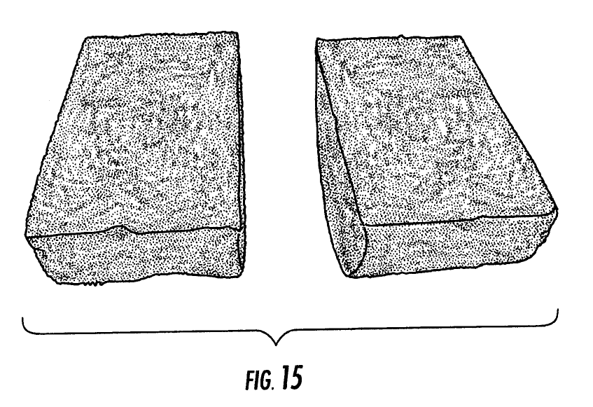

In a fifth test, Test “E” depicted in FIGS. 14 and 15, a 4.25-inch diameter by 2.5-inch thick binder-coated substrate was coated with activated carbon powder as in the previous tests, but the frequency of the sonic vibration device was set at 9,040 min⁻¹. When the powder-coated substrate was weighed and sliced in half, the loadings and distribution of the coating appeared to be optimized compared to the other tests. As shown in FIGS. 14 and 15, all of the interior of the binder-coated substrate appeared to be uniformly coated with activated carbon. The results of Tests A through E are shown in Table 1 herein.

TABLE 1
Activated Carbon Coating Test

| | Test A | Test B | Test C | Test D | Test E |
|---|---|---|---|---|---|
| Loading | 24 | 66 | 84 | 6 | 120 |
| (gms) | | | | | |
| Loading | 0.68 | 1.86 | 2.37 | 0.17 | 3.38 |
| (gms/in³) | | | | | |
| Frequency | 5,520 | 6,250 | 6,880 | — | 9,040 |
| (min⁻¹) | | | | | |
| Vacuum | 35 | 35 | 35 | 35 | 35 |
| (inches of | | | | | |
| water) | | | | | |

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. A filter assembly for removing contaminants from a fluid, the filter assembly comprising:
a filter housing having an inlet, an outlet and a chamber extending through the filter housing;
a filter cartridge positioned in the chamber of the filter housing, the filter cartridge constructed from a fibrous material used to filter contaminants from a fluid, the filter cartridge having a passageway extending from a proximal end of the filter cartridge to a distal end of the filter cartridge; and
a reticulated foam fluid treatment media disposed within a portion of the passageway of the filter cartridge, wherein the reticulated foam fluid treatment media comprises a porous polymeric substrate having surfaces including pore walls, and particles secured to the surfaces of the porous polymeric substrate via a binder, the particles being substantially uniformly distributed throughout the porous polymeric substrate via sonic vibration of the porous polymeric substrate and particles.

2. The filter assembly of claim 1, wherein the reticulated foam fluid treatment media is a substantially flexible reticulated foam fluid treatment media.

3. The filter assembly of claim 1, wherein the particles are selected from the group consisting of metal, metal oxide, rare earth and carbon particles, and wherein the particles are substantially uniformly distributed throughout the porous polymeric substrate in an amount in the range of from about 1.5 g to about 15 g per in³ of porous polymeric substrate.

4. The filter assembly of claim 1, wherein the particles comprise carbon particles and wherein the particles are substantially uniformly distributed throughout the porous polymeric substrate in an amount in the range of from about 1.5 g to about 5 g per ft³ of porous polymeric substrate.

5. The filter assembly of claim 4, wherein the carbon particles comprise activated carbon particles.

6. The filter assembly of claim 1 wherein the filter housing has a cartridge retainer disposed adjacent the outlet of the housing for stabilizing the reticulated foam fluid treatment media within the passageway of the filter cartridge.

7. The filter assembly of claim 1 wherein a piece of fluid permeable material is disposed about at least a portion of the reticulated foam fluid treatment media to stabilize the reticulated foam fluid treatment media within the passageway of the filter cartridge.

8. The filter assembly of claim 1, wherein the reticulated foam fluid treatment media and the porous polymeric substrate are substantially flexible, and wherein the binder is compatible with the flexible porous polymeric substrate and is disposed on the flexible porous polymeric substrate to provide a layer of binder on the flexible porous polymeric substrate surfaces.

9. A filter assembly for removing contaminants from a fluid, the filter assembly operably connected to a supporting structure, the filter assembly comprising:
a filter housing having an inlet, an outlet and a chamber extending through the filter housing;
a filter cartridge positioned in the chamber of the filter housing, the filter cartridge constructed from a fibrous material used to filter contaminants from a fluid; and
a substantially flexible reticulated foam fluid treatment media embedded within the filter cartridge, wherein the reticulated foam fluid treatment media comprises a flexible porous polyurethane substrate having surfaces including pore walls, and particles secured to the surfaces of the porous polyurethane substrate via a binder, the particles being substantially uniformly distributed throughout the porous polyurethane substrate via sonic vibration of the porous polyurethane substrate and particles.

10. The filter assembly of claim 9, wherein the binder is compatible with the flexible porous polyurethane substrate and is disposed on the surfaces of the flexible porous polyurethane substrate to provide a layer of binder on the pore walls of the flexible porous polyurethane substrate, and wherein the particles are adapted to substantially remove selected contaminants from fluids contacted with the substantially flexible reticulated foam fluid treatment media.

11. The filter assembly of claim 10, wherein the particles comprise activated carbon particles, and wherein the particles are substantially uniformly distributed throughout the porous polyurethane substrate in an amount in the range of from about 1.5 g to about 5 g per in³ of porous polyurethane substrate.

12. A method for producing flexible reticulated foam fluid treatment media for removing contaminates from fluids, the method comprising the steps of:
providing a flexible porous polymeric substrate;
coating the flexible porous polymeric substrate with a binder compatible with the flexible porous polymeric substrate;
compressing the coated flexible porous polymeric substrate using a roller or pair of rollers to press the binder into pores of the flexible porous polymeric substrate, to remove excess binder from the pores of the flexible foam substrate, and to allow re-expansion of the flexible porous polymeric substrate to provide a coated flexible porous polymeric substrate having tacky surfaces;
applying an effective amount of particles on a first face of the coated flexible porous polymeric substrate and applying sonic vibration to substantially uniformly distribute the particles throughout the porous polymeric substrate and uniformly coat the tacky surfaces of the coated flexible porous polymeric substrate with the particles, thereby providing a particle coated flexible porous polymeric substrate, the particles being selected from the group consisting of metal particles, metal oxide particles, rare earth particles, carbon particles and combinations thereof.

13. The method of claim 12, wherein the particles are substantially uniformly distributed throughout the porous polymeric substrate in an amount in the range of from about 1.5 g to about 15 g per in³ of porous polymeric substrate.

14. The method of claim 12, wherein the particles comprise activated carbon.

15. The method of claim 12, wherein the particles comprise activated carbon and the activated carbon particles are substantially uniformly distributed throughout the porous polymeric substrate in an amount in the range of from about 1.5 g to about 5 g per in³ of porous polymeric substrate.

16. The method of claim 12, wherein the sonic vibration is applied at a frequency in the range of from about 6,000 min⁻¹ to about 20,000 min⁻¹.

17. The method of claim 12, wherein the step of applying an effective amount of particles on a first face of the coated flexible porous polymeric substrate and applying sonic vibration further comprises:
applying a vacuum to a second face of the porous polymeric substrate to work in combination with the sonic vibration to substantially uniformly distribute the particles throughout the porous polymeric substrate and uniformly coat the tacky surfaces of the coated flexible porous polymeric substrate with the particles.

18. The method of claim 17, wherein the vacuum applied is in the range of from about 30 inches to about 100 inches of water.

19. The method of claim 12, further comprising the step of:
drying the particle coated flexible porous polymeric substrate to cure the binder and provide a reticulated foam fluid treatment media having a flexible, durable sponge-like structure.
